(19) United States
(12) Patent Application Publication
(10) Pub. No.: US 2024/0154262 A1
(43) Pub. Date: May 9, 2024

(54) BATTERY

(71) Applicant: Panasonic Intellectual Property Management Co., Ltd., Osaka (JP)

(72) Inventor: EIICHI KOGA, Hokkaido (JP)

(21) Appl. No.: 18/414,629

(22) Filed: Jan. 17, 2024

Related U.S. Application Data
(63) Continuation of application No. PCT/JP2022/022900, filed on Jun. 7, 2022.

(30) Foreign Application Priority Data
Aug. 5, 2021 (JP) 2021-129387

(51) Int. Cl. H01M 50/533

(52) U.S. Cl. CPC H01M 50/533

(57) ABSTRACT

A battery of the present disclosure includes: a first battery element; a second battery element laminated on the first battery element and electrically coupled with the first battery element in parallel; and a first lead terminal electrically coupled with the first battery element and the second battery element, in which the first lead terminal has a non-contact portion that is not in contact with any of the first battery element and the second battery element, and the non-contact portion has a first embossed shape at least on a part of a surface.

### BACKGROUND

### 1. Technical Field

The present disclosure relates to a battery.

### 2. Description of the Related Art

Japanese Unexamined Patent Application Publication No. 2011-70989 (hereinafter referred to as Patent Document 1) discloses a battery in which a voltage sensing terminal is coupled with a current collector.

International Publication No. WO 2010/116872 (hereinafter referred to as Patent Document 2) discloses an electricity storage device including a current collector in which a plurality of grooves is formed.

### SUMMARY

One non-limiting and exemplary embodiment provides a battery with improved reliability.

In one general aspect, the techniques disclosed here feature a battery including: a first battery element; a second battery element laminated on the first battery element and electrically coupled with the first battery element in parallel; and a first lead terminal electrically coupled with the first battery element and the second battery element, in which the first lead terminal has a non-contact portion that is not in contact with any of the first battery element and the second battery element, and the non-contact portion has a first embossed shape at least on a part of a surface.

The present disclosure provides a battery with improved reliability.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a sectional view and a plan view illustrating a schematic configuration of a battery according to a first embodiment;

FIG. 2 is a sectional view and a plan view illustrating a schematic configuration of an embossed pattern of the battery according to the first embodiment;

FIG. 3 is a sectional view and a plan view illustrating a schematic configuration of a battery according to a second embodiment;

FIG. 4 is a sectional view and a plan view illustrating a schematic configuration of a battery according to a third embodiment;

FIG. 5 is a plan view illustrating an outer edge and a schematic configuration of an embossed pattern of the battery according to the third embodiment;

FIG. 6 is a sectional view and a plan view illustrating a schematic configuration of a battery according to a fourth embodiment;

FIG. 7 is a sectional view and a plan view illustrating a schematic configuration of a battery according to a fifth embodiment; and

FIG. 8 is a sectional view and a plan view illustrating a schematic configuration of a battery according to a sixth embodiment.

### DETAILED DESCRIPTIONS

In the following, embodiments of the present disclosure is described specifically with reference to the drawings.

All of the embodiments described below are general and specific examples. Numerical values, shapes, materials, arrangement of positions and coupling forms of components, manufacturing processes, order of the manufacturing processes, or the like described in the following embodiments are merely examples and not intended to limit the present disclosure.

In this specification, terms, such as parallel, which indicate a relationship between elements and terms, such as a cuboid, which indicate a shape of elements, as well as numerical value ranges are not expressions that express only strict meanings, but expressions meaning that a range substantially equivalent to, for example, a difference of about several percent is also included.

Each figure is a schematic diagram and not necessarily strictly illustrated. Therefore, for example, scales or the like do not necessarily match in each drawing. In addition, in each figure, identical symbols are assigned to substantially identical structures, and an overlapping description thereof is omitted or simplified.

In this specification and drawings, x-axis, y-axis and z-axis represent three axes of a three-dimensional orthogonal coordinate system. In each embodiment, the z-axis direction is a thickness direction of the battery. In addition, in this specification, unless otherwise specified, the term “thickness direction” refers to a direction perpendicular to a surface on which layers of a battery and battery elements are laminated.

In the present specification, unless otherwise specified, “plan view” means a case where the battery is viewed along a laminating direction of the battery elements. In this specification, unless otherwise specified, a “thickness” is a length of the battery, the battery element, and each layer in the laminating direction.

In this specification, unless otherwise specified, in the battery and the battery element, a “side surface” means a surface along the laminating direction of the battery element, and a “main surface” means a surface other than the side surface.

In this specification, “inside” and “outside” in “inner side” and “outer side” mean that the center side of the battery is “inside” and the periphery side of the battery is “outside”, when the battery is viewed along the laminating direction of the battery elements.

In this specification, the terms “top” and “bottom” in configurations of the battery are used as terms defined by a relative positional relationship based on the laminating order in the laminating structure, rather than as terms referring to the upward (vertically upward) and downward (vertically downward) directions in absolute spatial awareness. In addition, the terms “above” and “below” are used not only when two components are spaced apart from each other and another component interposed therebetween, but also when two components are placed close to each other and are in contact with each other.

### First Embodiment

In the following, a description is given of a battery according to a first embodiment.

A battery according to the first embodiment includes a first battery element, a second battery element, and a first lead terminal. The second battery element is laminated on the first battery element and is electrically coupled in parallel with the first battery element. The first lead terminal is electrically coupled with the first battery element and the second battery element. The first lead terminal includes a non-contact portion that is not in contact with any of the first battery element and the second battery element. The non-contact portion in the first lead terminal has a first embossed shape at least on a part of a surface. The first lead terminal may be arranged between the first battery element and the second battery element. The first lead terminal may include a contact portion that is in contact with at least one battery element of the group consisting of the first battery element and the second battery element. Note that in other words, the above-described non-contact portion in the first lead terminal can be said to be an exposed portion that protrudes outward from a side surface of a laminated body of the first battery element and the second battery element. In the following, the side surface of the laminated body of the first battery element and the second battery element may be referred to as a “battery element side surface”.

In the present specification, the first embossed shape provided on the at least part of the surface of the first lead terminal means a shape formed by at least one of convex shapes on the surface of the first lead terminal or concave shapes on the surface. That is, the first embossed shape may be formed by the convex shapes or the concave shapes formed on the surface of the first lead terminal, or both of the convex shapes and the concave shapes (more specifically, the convex and concave shapes). Note that embossment has single-sided embossment and double-sided embossment, but the embossed shape in the present disclosure may be any of them.

According to the above configuration, even when stress such as shock or vibration is applied to a battery, the first embossed shape can absorb and disperse action of the above stress on a lead-out portion (that is, the non-contact portion described above) of the first lead terminal. As a result, it is possible to suppress breakage of the first lead terminal due to a starting point of damage that occurs at an outer edge of the lead-out portion of the first lead terminal, for example. Therefore, it is possible to reduce occurrence of circuit disconnection due to the damage of the lead terminal (that is, open failure). Hence, according to a configuration of the battery according to the first embodiment, even a multi-layer battery in which a plurality of thin-layered and large battery cells is laminated can have high reliability and large capacity.

As set forth in the “Background” section, Patent Document 1 discloses a battery with a voltage sensing terminal coupled with a current collector. However, the battery has a concave portion in communication with the current collector, and the voltage sensing terminal is in contact with and coupled with the concave portion. As a result, the concave portion in the battery disclosed in Patent Document 1 is located at a coupled part between the voltage sensing terminal and the current collector, that is, a contact portion with the current collector in the voltage sensing terminal. Therefore, the battery disclosed in Patent Document 1 is not a battery, like the battery according to the first embodiment, in which concavities and convexities, that is, embossed shapes, are provided on the non-contact portion (that is, the exposed portion) of the first lead terminal that is not in contact with any of the first battery element and the second battery element.

Patent Document 2 discloses an electricity storage device including a current collector in which a plurality of grooves is formed. The configuration is intended to reduce resistance in a contact portion between an electrode layer containing active substances and a current collector. Therefore, no grooves are provided on the non-contact portion (that is, the exposed portion) of the lead terminal. As a result, in the electricity storage device of Patent Document 2, grooves provided in a coupled part between the electrode layer and the current collector do not have workings and effects of suppressing damage to the lead terminal, unlike the battery according to the first embodiment does.

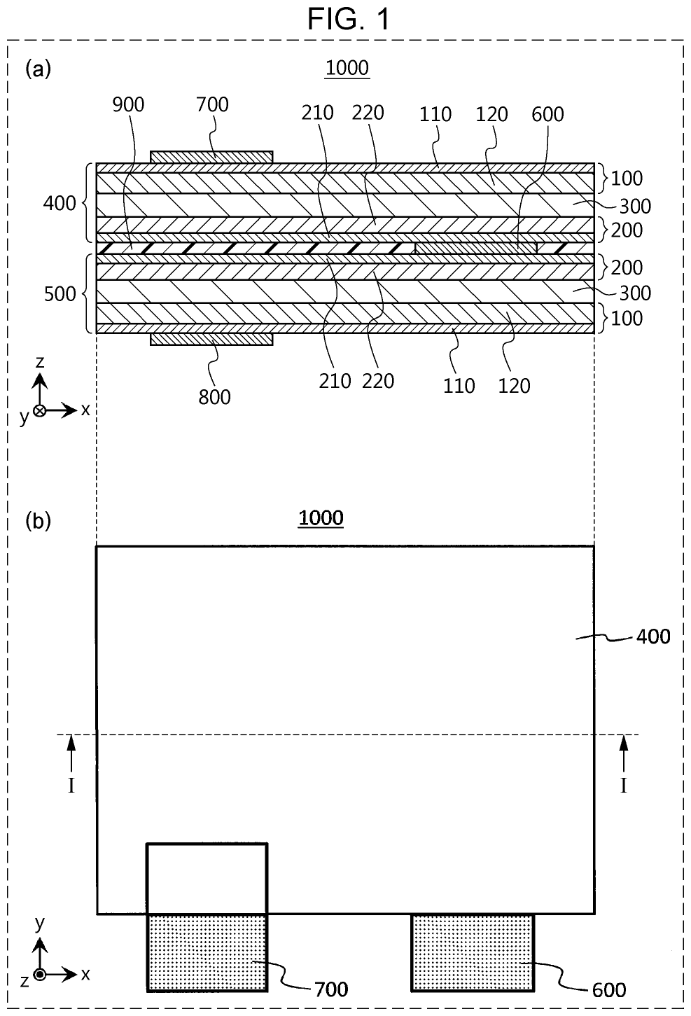

FIG. 1 is a sectional view and a plan view illustrating a schematic configuration of a battery 1000 according to the first embodiment.

FIG. 1(a) illustrates a sectional view of the battery 1000 according to the first embodiment. FIG. 1(b) is a plan view of the battery 1000 according to the first embodiment when viewed from a positive side of a z-axis direction. FIG. 1(a) illustrates a cross section at a position depicted by I-I line of FIG. 1(b).

As illustrated in FIG. 1, the battery 1000 includes a first battery element 400, a second battery element 500, and a first lead terminal 600. The first battery element 400 and the second battery element 500 are laminated together and are electrically coupled with each other. The first lead terminal 600 is arranged between the first battery element 400 and the second battery element 500 and is electrically coupled in parallel with the first battery element 400 and the second battery element 500. The battery 1000 according to the first embodiment further includes, for example, a second lead terminal 700 electrically coupled with the first battery element 400, and a third lead terminal 800 electrically coupled with the second battery element 500. That is, in the battery 1000, for example, the second lead terminal 700, the first battery element 400, the first lead terminal 600, the second battery element 500, and the third lead terminal 800 are arranged in this order in the laminating direction of the first battery element 400 and the second battery element 500.

As illustrated in FIG. 1(b), the first lead terminal 600 has the first embossed shape at least on a part of the non-contact portion that is not in contact with any of the first battery element 400 and the second battery element 500. Note that in FIG. 1(b), the first embossed shape is represented by dot pattern applied to the first lead terminal 600. In the battery 1000 according to the first embodiment, the first embossed shape is provided, for example, on substantially the entire non-contact portion of the first lead terminal 600.

According to the above configuration, even when stress such as shock or vibration is applied to the battery 1000, the first embossed shape can absorb and disperse the action of the above stress on the above non-contact portion, which is a lead-out portion of the first lead terminal 600. As a result, it is possible to suppress breakage of the first lead terminal 600 due to a starting point of damage that occurs at an outer edge of a lead-out portion of the first lead terminal 600, for example. Therefore, it is possible to reduce occurrence of circuit disconnection due to the damage of the lead terminal. Hence, the battery 1000 can have high reliability and large capacity.

As described above, the battery 1000 is a laminated battery in which two battery elements are coupled in parallel.

The first battery element 400 and the second battery element 500 are, for example, solid-state batteries. That is, the battery 1000 may be an all solid-state battery. If the first battery element 400 and the second battery element 500 are solid-state batteries, the first lead terminal 600 is fixed between the first battery element 400 and the second battery element 500. Thus, the first lead terminal 600 becomes more susceptible to damage due to stress such as shock or vibration. In the battery 1000 according to the first embodiment, however, as the non-contact portion of the first lead terminal 600 has the first embossed shape at least on the part of the surface, the first lead terminal 600 is not damaged easily even when the battery 1000 is an all-solid-state battery.

As illustrated in FIG. 1(b), similarly to the first lead terminal 600, the second lead terminal 700 may have the first embossed shape on a portion not in contact with the battery element, that is, in the battery 1000, at least on a part of the non-contact portion that is not in contact with the first battery element 400. The first embossed shape may be provided particularly on a portion protruding outward from a side surface of the battery element, of the non-contact portion of the second lead terminal 700. The second lead terminal 700 having the first embossed shape like the above configuration, similarly to the first lead terminal 600, breakage of the second lead terminal 700 may be suppressed even when the stress such as shock or vibration is applied to the battery 1000. Note that in FIG. 1(b), the first embossed shape provided on the second lead terminal 700 is represented by applying dot pattern to the second lead terminal 700.

As illustrated in FIG. 1(b), similarly to the first lead terminal 600, the third lead terminal 800 may have the first embossed shape on the portion not in contact with the battery element, that is, in the battery 1000, at least on the part of the non-contact portion that is not in contact with the second battery element 500. The first embossed shape may be provided particularly on the portion protruding outward from the side surface of the battery element, of the non-contact portion of the second lead terminal 700. The third lead terminal 800 having the first embossed shape like the above configuration, similarly to the first lead terminal 600, breakage of the third lead terminal 800 may be suppressed even when the stress such as shock or vibration is applied to the battery 1000.

The first battery element 400 includes a first electrode 100, a solid electrolyte layer 300, and a second electrode 200 in this order. The first electrode 100 includes a first current collector 110 and a first active material layer 120. The second electrode 200 includes a second current collector 210 and a second active material layer 220.

Similarly to the first battery element 400, the second battery element 500 includes the first electrode 100, the solid electrolyte layer 300 and the second electrode 200 in this order. Similarly to the first battery element 400, also in the second battery element 500, the first electrode 100 includes the first current collector 110 and the first active material layer 120, and the second electrode 200 includes the second current collector 210 and the second active material layer 220. Note that the first electrode 100 of the second battery element 500 is an electrode having same polarity as the first electrode 100 of the first battery element 400. The second electrode 200 of the second battery element 500 is an electrode having the same polarity as the second electrode 200 of the first battery element 400.

As illustrated in FIG. 1(a), the first battery element 400 is laminated on the second battery element 500 so that the second current collector 210 of the first battery element 400 is opposed to the second current collector 210 of the second battery element 500. Alternatively, the first battery element 400 may be laminated on the second battery element 500 so that the first current collector 110 of the first battery element 400 is opposed to the first current collector 110 of the second battery element 500. That is, as far as the first battery element 400 and the second battery element 500 are laminated so as to be electrically coupled in parallel, an orientation thereof is not limited to that illustrated in FIG. 1(a).

In addition to the first lead terminal 600, another conductive layer 900, for example, may be arranged between the first battery element 400 and the second battery element 500.

Only the first lead terminal 600 may be arranged between the first battery element 400 and the second battery element 500.

The first electrode 100 may be a positive electrode and the second electrode 200 may be a negative electrode. In this case, the first current collector 110 and the first active material layer 120 are a positive electrode current collector and a positive electrode active material layer, respectively. The second current collector 210 and the second active material layer 220 are a negative electrode current collector and a negative electrode active material layer, respectively.

In the following, the first current collector 110 and the second current collector 210 may be collectively referred to simply as “current collectors”. The first active material layer 120 and the second active material layer 220 may be collectively referred to simply as “active material layers”. The first lead terminal 600, the second lead terminal 700, and the third lead terminal 800 may be collectively referred to simply as “lead terminals”.

In FIG. 1, the first battery element 400 and the second battery element 500 are shaped like a flattened cuboid.

In FIG. 1, the first lead terminal 600 is arranged between the first battery element 400 and the second battery element 500. If the conductive layer 900 is provided, similarly to the first lead terminal 600, the conductive layer 900 is also arranged between the first battery element 400 and the second battery element 500.

The conductive layer 900 is formed of a conductive material. The conductive material includes a conductor. The conductive material may be a conductive resin material. The conductive resin material includes conductive particles, for example. The conductive particles are powder such as Ag or Cu, for example.

The second lead terminal 700 and the third lead terminal 800 are coupled with upper and lower main surfaces of the battery 1000 by, for example, a conductive material. In the battery 1000 illustrated in FIG. 1, the second lead terminal 700 is electrically coupled with an electrode with different polarity from an electrode to which the first lead terminal 600 is electrically coupled in the first battery element 400. In addition, the third lead terminal 800 is electrically coupled with an electrode with different polarity from an electrode to which the first lead terminal 600 is electrically coupled in the second battery element 500.

A lead terminal has, for example, a foil-like, plate-like, or mesh-like shape. The first lead terminal 600 has the embossed shape on an exposed portion from the first battery element 400 and the second battery element 500. That is, the first lead terminal 600 has the embossed shape in the non-contact portion that is not in contact with the first battery element 400 and the second battery element 500.

The second lead terminal 700 may have a same shape as the third lead terminal 800. As a result, stress can be dispersed because a same degree of load is applied to both lead terminals when shock or the like acts. This suppresses damage to the lead terminal. In addition, as drawn portions of same polarity have same electrical resistance, heat generated at high current will also be substantially same. Therefore, as local differences in battery operation due to temperature differences are reduced and characteristic degradation is suppressed, high reliability can be obtained.

A material of the lead terminal may be conductive. Examples of the material include stainless, nickel (Ni), aluminum (Al), iron (Fe), titanium (Ti), copper (Cu), palladium (Pd), gold (Au), platinum (Pt), or an alloy of two or more kinds thereof. The material of the lead terminal may be appropriately selected considering an operating potential and conductivity of the battery 1000. In addition, the material of the lead terminal may be selected according to required tensile strength or heat resistance. The lead terminal may be a high-strength electrolytic copper foil or a clad material of laminated dissimilar metal foils. A surface of the lead terminal may be plated with and formed of a conductor such as Ni, Cu, or Sn.

The first embossed shape of the lead terminal may be, for example, concavities and convexities having maximum height roughness Rz (JIS B 0601:2013) sized about the thickness of the lead terminal. For example, if the first lead terminal 600 is a Cu foil having a thickness from 10 μm to 15 μm, the first embossed shape provided on the first lead terminal 600 may include the concavities and convexities having the maximum height roughness Rz from 10 μm to 15 μm, for example.

The first embossed shape provided on the lead terminal may have a periodic structure in which embossed unit shapes are repeatedly arranged at predetermined intervals. Hereinafter, the embossed shape having the periodic structure in which the embossed unit shapes are repeatedly arranged at predetermined intervals may be referred to as an “embossed pattern”. The embossed pattern makes it possible to disperse and absorb locally concentrated stress on the lead terminal into a wider area provided with the periodic structure. For example, it is possible to suppress progress of damage by dividing breakage that progresses in a line, which is a common form of breakage of lead terminals, by means of the periodic structure of embossing, in which a plurality of the embossed unit structures (unit concave shape or unit convex shape, for example) is arranged. Therefore, the battery 1000 can suppress the breakage of the first lead terminal 600 and, as a result, can suppress the occurrence of circuit disconnection. Furthermore, for flexural deformation of the lead terminal caused by stress, because provision of the embossed pattern improves shape retainability, the lead terminal becomes more resistant to deformation than a smooth foil-like state (that is, a thin plate-like state in which no embossed shapes are provided). As a result, the deformation of the lead terminal is suppressed, so that metal fatigue of metal materials included in the lead terminal is reduced. Consequently, the lead terminal is not damaged easily.

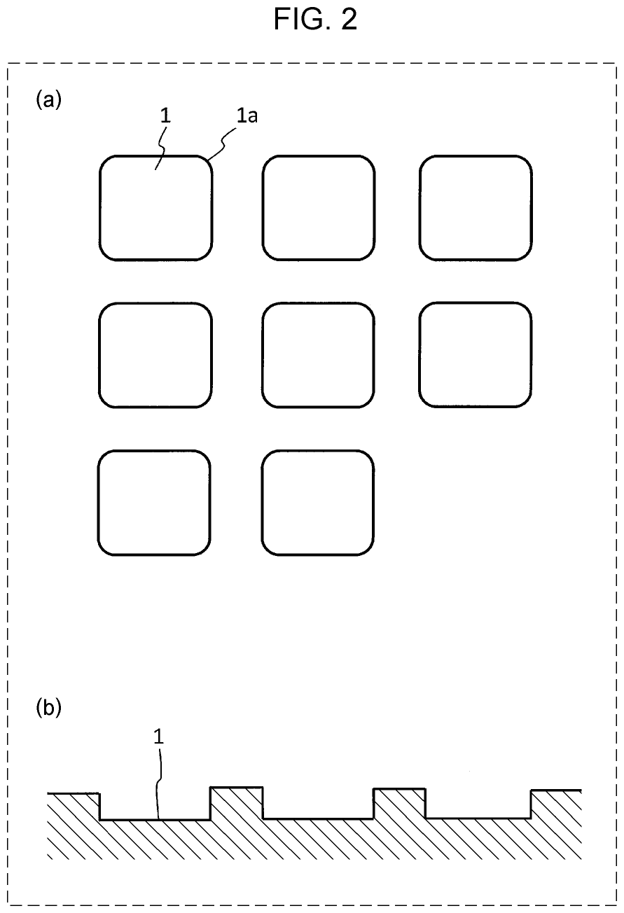

The first embossed shape may be, for example, an embossed pattern in which the embossed unit shape is the unit concave shape. The embossed pattern may have, for example, a periodic structure in which the unit concave shapes are arranged at intervals of 50 μm (that is, at a pitch of 50 μm), the unit concave shape being a square of 100 μm×100 μm and having a thickness (that is, a depth of the concavity) of 10 μm. FIG. 2 illustrates a schematic diagram of an example of such a shape. FIG. 2 is a sectional view and a plan view illustrating a schematic configuration of the embossed pattern of the battery 1000 according to the first embodiment.

FIG. 2(a) is a plan view illustrating a schematic configuration of an example of the embossed pattern of the battery 1000 according to the first embodiment. FIG. 2(b) is a sectional view illustrating the embossed pattern of the battery 1000 according to the first embodiment.

A corner part 1a of the unit concave shape 1 may be smoothly curved. That is, the corner part of the unit concave shape 1 may not have to be pointed.

In light of a case in which variation in the thickness of the lead terminal is generally about ±30% (that is, a difference between the maximum thickness (that is, the thickness of +30%) and the minimum thickness (that is, the thickness of −30%)=approximately 60% of the thickness), the depth of the unit concave shape 1 may be made an embossed thickness of greater than or equal to an average thickness of the lead terminal (that is, greater than or equal to approximately 1.5 times of the thickness variation). This provides significant workings and effects of the embossed shape, without being absorbed in the thickness variation. Note that the smaller the pitch (interval) of the arrangement of the unit concave shapes 1 in the embossed shape is, the higher the stretchability of the lead terminal is. Therefore, as the pitch of the arrangement of the unit concave shape 1 becomes smaller, stress resistance and heat dissipation of the lead terminal improve. A thickness level of the conductive material may be set as an upper limit of the pitch of the arrangement, although this depends on workability of the conductive material forming the lead terminal. For example, in the case of a general thin-layer Cu current collecting foil, the pitch may be about less than or equal to 10 μm.

As described above, provision of the first embossed shape in the lead terminal makes it possible to suppress the breakage of the lead terminal due to stress and shock. In addition, the first embossed shape makes it difficult for the lead terminal to be damaged and the concavities and convexities provide the stretchability against stress. Thus, stress can be absorbed by the stretchability of the entire lead terminal. Therefore, it is desirable that the lead terminal have stretchability increased by the pattern, the arrangement, and the pitch of concavo-convex processing. The stretch characteristic of lead terminals can be evaluated by a general tensile test that measures displacement against tensile stress.

The embossed unit shapes forming the embossed pattern are not limited to the shapes illustrated in FIG. 2, and a lattice-like, hexagonal, or circular shape or the like may be used. The embossed unit shape may be single-sided embossment or double-sided embossment.

When the first embossed shape has a periodic structure, the periodic structure may have a configuration in which a plurality of the embossed unit shapes is arranged with an interval greater than or equal to the thickness of the first lead terminal 600. As a result, the periodic structure, in which the embossed unit shapes are repeatedly arranged at an interval greater than or equal to the variation in the thickness of commonly used lead terminals (for example, the thickness of the Cu current collector foil), is formed on the surface of the lead terminal. Consequently, the periodic structure of the first embossed shape can disperse and absorb the stress concentrated on a thin region of the lead terminal. Therefore, damage due to stress such as shock and vibration can be suppressed. The periodic structure may have an interval greater than or equal to 10 μm.

The first embossed shape may include a plurality of a linear embossed shapes. The plurality of linear embossed shapes may or may not be parallel to each other. For example, the first embossed shape may have a shape in which a plurality of straight lines is arranged in parallel (in a line). Arrangement of the linear embossed shapes so as to divide the line along which breakage progresses makes it possible to suppress the progress of the breakage. In this case, it is desirable that a direction in which the linear embossed shapes extend be not parallel to a direction in which the outer edge of the battery 1000 extends. That is, the embossed shape may include a linear embossed shape that is not parallel to, that is, intersecting, a direction in which the outer edges of the first battery element 400 and the second battery element 500 extend, in plan view. As a result, the linear embossed shape linearly divides the direction in which the lead terminal is easily damaged, so that the stress resistance of lead terminals is improved. In particular, arrangement of the linear embossed shape perpendicular to the direction in which the outer edges of the first battery element 400 and the second battery element 500 extend strengthens the lead terminal against stress in the direction along the outer edges of the first battery element 400 and the second battery element 500. The linear embossed shape may be arranged obliquely with respect to the direction in which the outer edges of the first battery element 400 and the second battery element 500 extend.

The linear embossed shape may be formed of linear concavities (groove like) or linear convexities, or may be formed by the embossed unit shapes being arranged in a line.

When, in addition to the first lead terminal 600, the second lead terminal 700 and the third lead terminal 800 have the first embossed shape, a structure of the first embossed shape may be same for all lead terminals or may be different from each other. Similarly to the first lead terminal 600, it is also possible to improve the second lead terminal 700 and the third lead terminal 800 in resistance to stress such as tensile stress.

The first embossed shape may be located at an outer edge part of the lead terminal. The outer edge part of the lead terminal easily becomes the starting point of damage. Therefore, by the lead terminal having the above configuration, it becomes easier to suppress the progress of the damage of the lead terminal. For example, as the outer edge part of the lead terminal has burrs or scratches formed during processing such as die punching, it easily becomes the starting point of damage. Provision of the first embossed shape in such an outer edge part can reduce the damage of the lead terminal due to burrs or scratches.

The first embossed shape may be arranged at a part along a long side of the outer edge part of the lead terminal in plan view. This can protect the part along the long side of the outer edge part that easily becomes the starting point of damage.

As illustrated in FIG. 1(b), the first battery element 400 and the second battery element 500 have a square-shaped outer circumferential shape made up of four sides, for example. For example, the approximate outlines of the first battery element 400 and the second battery element 500 may each be roughly 120 mm of a long side×90 mm of a short side×a thickness of 200 μm. The lead terminal may be drawn out with a width of 15 mm, for example, and a thickness of the lead terminal in this case may be, for 10 μm, for example.

As illustrated in FIG. 1(b), although the first embossed shape is provided in the non-contact portion of the first lead terminal 600, it is not limited to this. For example, the first embossed shape may be provided only on an outer edge part of the non-contact portion, that is, a site that easily becomes the starting point of damage. This can enhance the effect of suppressing the damage of the first lead terminal 600. In particular, deformation stress of bending from a hard side surface strongly acts on a drawn portion from the battery element side surface in the first lead terminal 600 (that is, the site immediately after being drawn out from the battery element), so that the first lead terminal 600 is easily damaged. Therefore, in order to further suppress the damage of the first lead terminal 600, the first embossed shape may be provided around the drawn portion from the side surface of the battery 1000 of the first lead terminal 600. Furthermore, the embossed shape may be provided even at a part along the side surface of the battery element in the first lead terminal 600 (that is, the part where the damage progresses), in addition to the outer edge part around the drawn portion of the first lead terminal 600 (that is, the site that easily becomes the starting point of damage). That is, for the part along the side surface of the battery element in the first lead terminal 600, the embossed shape may be provided even to a part where the first lead terminal 600 is in contact with the first battery element 400 and/or the second battery element 500. This can selectively protect the starting point of damage and the area where the damage occurs easily, for the first lead terminal 600. It is needless to say that when the first embossed shape is provided on the entire surface of the non-contact portion of the first lead terminal 600, the effect that can protect the starting point of damage and the area where the damage occurs easily can be obtained. Such workings and effects by the first embossed shape are also the same for the second lead terminal 700 and the third lead terminal 800.

As the embossed shape increases a surface area of the lead terminal, an effect of dissipating heat through the lead terminal can also be obtained. Therefore, deterioration of the battery characteristics in high-temperature operations can also be suppressed. In order to enhance the effect of heat dissipation, the material of the lead terminal may have a large thermal conductivity. It is possible to increase the surface area of the lead terminal to enhance the heat dissipation performance, by increasing the concavities and convexities of the embossed shape and then reducing the pitch of the embossed pattern.

In the following, a specific configuration of the battery 1000 is described.

As illustrated in FIG. 1, the first lead terminal 600 extends and is exposed from the side surfaces of the first battery element 400 and the second battery element 500. The first lead terminal 600 is, for example, an integral body continuing from a plate-like conductive material (conductive foil having a thickness of approximately 10 μm to 16 μm, for example). Note that for example, a Cu foil may be used as the conductive foil. The conductive layer 900 and the first lead terminal 600 may be configured by a continuous integral member. Such an integral configuration allows a bonded face to ensure flatness, rather than partially inserting the first lead terminal 600 into the bonded surface between the first battery element 400 and the second battery element 500. This improves bondability between the first battery element 400 and the second battery element 500, and can suppress structural defects, such as interfacial debonding between the battery elements. In addition, the integral configuration as described above can also improve the tensile strength of the first lead terminal 600. Furthermore, the integral configuration can suppress the heat resistance between the conductive layer 900 and the first lead terminal 600 (that is, increased resistance loss due to discontinuous portion can be reduced), so that an action of releasing heat generated in charging and discharging operations is also enhanced.

The embossed shape to be provided on the lead terminal may be formed by pressing a die onto a predetermined portion of the plate-like conductive material to form concavities and convexities on the above-described material. The embossed pattern may be formed at least on a part of the surface of the lead terminal by periodically arranging the embossed unit shapes of the unit concave shapes or the unit convex shapes, that is, by repeatedly arranging the embossed unit shapes at predetermined intervals. As described above, the embossed pattern may have, for example, the periodic structure in which the unit concave shapes are arranged at intervals of 50 μm (that is, at a pitch of 50 μm), the unit concave shape being a square of 100 μm×100 μm and having a thickness (that is, a depth of the concavity) of 10 μm.

The lead terminal may only have to be a conductor, and in particular, a conductor with high conductivity is desirable. In addition, metal having excellent workability and good plastic deformation performance is desired. The lead terminal may include the same material as the current collectors that configure the battery elements. As a result, the lead terminals and the current collectors have a same thermal expansion coefficient, so that thermal shock resistance is improved and, as a result, the structural defects such as the delamination may be suppressed.

The first battery element 400 and the second battery element 500 may be laminated on each other by being respectively bonded with upper and lower main surfaces of the plate-like conductive material such as Cu foil that configures the conductive layer 900 and the first lead terminal 600, by means of a conductive resin. For example, a thermosetting conductive resin containing metal conductive particles with high conductivity can be used for the conductive resin. In addition, solder may be melted for bonding. The conductive particles may be metal powders such as Ag and Cu. A particle size of the conductive particles may be, for example, 0.5 μm to 5 μm.

The battery 1000 may be configured by three or more battery elements being laminated and electrically coupled in parallel. Each of the battery elements may not have to be a single battery or may be two or more assembled batteries.

The approximate shape of any of the first current collector 110, the first active material layer 120, the solid electrolyte layer 300, the second active material layer 220, and the second current collector 210 may be rectangular in plan view.

In FIG. 1, the first current collector 110, the first active material layer 120, the solid electrolyte layer 300, the second active material layer 220, and the second current collector 210 mutually have a same size, and contour of each of them matches in plan view, but are not limited to this.

The first active material layer 120 may be smaller than the second active material layer 220.

The first active material layer 120 and the second active material layer 220 may be smaller than the solid electrolyte layer 300.

For example, when the solid electrolyte layer 300 covers at least one of the first active material layer 120 or the second active material layer 220, a part of the solid electrolyte layer 300 may be in contact with at least one of the first current collector 110 or the second current collector 210.

The current collector may be formed of a conductive material.

For the current collector, a foil-like, plate-like, or a mesh-like body including, for example, stainless, nickel (Ni), aluminum (Al), iron (Fe), titanium (Ti), copper (Cu), palladium (Pd), gold (Au), or platinum (Pt), or an alloy of two or more kinds thereof may be used.

The material of the current collector may be selected in consideration of a manufacturing process, an operating temperature, an operating pressure, a battery operating potential applied to the current collector, or electric conductivity. Alternatively, the material of the current collector may be selected in consideration of the tensile strength or heat resistance required for the battery. The current collector may be the high-strength electrolytic copper foil or the clad material of laminated dissimilar metal foils.

The current collector may have a thickness, for example, greater than or equal to 10 μm and less than or equal to 100 μm.

The surface of the current collector may be processed into a rough surface with concavities and convexities in order to increase adhesiveness to the active material layer (that is, the first active material layer 120 or the second active material layer 220). This, for example, enhances the bondability of current collector interfaces and improves mechanical and thermal reliability as well as cycle characteristic of the battery. Moreover, as a contact area between the current collector and a bonded portion 16 is increased, the electric resistance is reduced.

The first active material layer 120 may be in contact with the first current collector 110. The first active material layer 120 may cover the entire main surface of the first current collector 110.

A positive electrode active material layer contains a positive electrode active material.

The positive electrode active material is a material in which metal ions such as lithium (Li) ions or magnesium (Mg) ions are inserted into or removed from a crystal structure at a higher potential than the negative electrode, and oxidation or reduction is performed accordingly.

The positive electrode active material is, for example, a compound containing lithium and a transition metal element. The compound is, for example, an oxide containing lithium and a transition metal element or a phosphate compound containing lithium and a transition metal element.

Examples of oxides containing lithium and a transition metal element include a lithium nickel composite oxide such as LiNiₓM₁₋ₓO₂ (where M is at least one selected from the group of Co, Al, Mn, V, Cr, Mg, Ca, Ti, Zr, Nb, Mo, and W, and 0<x≤1 is satisfied), a layered oxide such as lithium cobalt oxide (LiCoO₂), lithium nickel oxide (LiNiO₂), and lithium manganate (LiMn₂O₄), or lithium manganate having a spinel structure (LiMn₂O₄, Li₂MnO₃, or LiMO₂, for example).

An example of a phosphate compound containing lithium and a transition metal element is lithium iron phosphate (LiFePO₄) having an olivine structure.

Sulfides such as sulfur (S) and lithium sulfide (Li₂S) may be used as the positive electrode active material. In this case, lithium niobate (LiNbO₃) or the like may be coated on or added to positive electrode active material particles.

For the positive electrode active material, only one of these materials may be used or two or more kinds of these materials may be used in combination.

In order to enhance lithium ion conductivity or electron conductivity, the positive electrode active material layer may contain a material other than the positive electrode active material, in addition to the positive electrode active material. That is, the positive electrode active material layer may be a mixture layer. Examples of the material include solid electrolytes such as inorganic solid electrolytes or sulfide-based solid electrolytes, a conductive auxiliary material such as acetylene black, or a binder for binding such as polyethylene oxide or polyvinylidene fluoride.

The first active material layer 120 may have a thickness greater than or equal to 5 μm and less than or equal to 300 μm.

The second active material layer 220 may be in contact with the second current collector 210. The second active material layer 220 may cover the entire main surface of the second current collector 210.

The negative electrode active material layer includes a negative electrode active material.

The negative electrode active material refers to a substance in which metal ions such as lithium (Li) ions or magnesium (Mg) ions are inserted into or removed from a crystal structure at a lower potential than the positive electrode, and oxidation or reduction is performed accordingly.

Examples of the negative electrode active material includes carbon material such as natural graphite, artificial graphite, graphite carbon fiber, and resin heat-treated carbon or alloy-based materials mixed with a solid electrolyte. Examples of the alloy-based materials include lithium alloys such as LiAl, LiZn, Li₃Bi, Li₃Cd, Li₃Sb, Li₄Si, Li_{4.4}Pb, Li_{4.4}Sn, Li_{0.17}C, and LiC₆; an oxide of lithium such as lithium (Li₄Ti₅O₁₂) and a transition metal element; and metal oxides such as zinc oxide (ZnO) or silicon oxide (SiOₓ).

For the negative electrode active material, only one of these materials may be used or two or more kinds of these materials may be used in combination.

In order to enhance lithium ion conductivity or electron conductivity, the negative electrode active material layer may contain a material other than the negative electrode active material, in addition to the negative electrode active material. Examples of the material include solid electrolytes such as inorganic solid electrolytes or sulfide-based solid electrolytes, a conductive auxiliary material such as acetylene black, or a binder for binding such as polyethylene oxide or polyvinylidene fluoride.

The second active material layer 220 may have a thickness greater than or equal to 5 μm and less than or equal to 300 μm.

The solid electrolyte layer 300 include a solid electrolyte. The solid electrolyte layer 300 contains, for example, a solid electrolyte as a main component. The solid electrolyte layer 300 may consist only of a solid electrolyte.

The solid electrolyte may be a publicly known solid electrolyte for batteries, having ionic conductivity. As the solid electrolyte, for example, a solid electrolyte that conducts metal ions such as lithium ions or magnesium ions may be used.

As the solid electrolyte, for example, an inorganic solid electrolyte such as a sulfide-based solid electrolyte or an oxide solid electrolyte may be used.

Examples of the sulfide-based solid electrolytes are Li₂S—P₂S₅ system, Li₂S—SiS₂ system, Li₂S—B₂S₃ system, Li₂S—GeS₂ system, Li₂S—SiS₂—LiI system, Li₂S—SiS₂—Li₃PO₄ system, Li₂S—Ge₂S₂ system, Li₂S—GeS₂—P₂S₅ system, or Li₂S—GeS₂—ZnS system.

Examples of the oxide-based solid electrolyte are a lithium-containing metal oxide, lithium phosphate (Li₃PO₄), or a lithium-containing transition metal oxide. Examples of the lithium-containing metal oxide include Li₂O—SiO₂ or Li₂O—SiO₂—P₂O₅. Examples of the lithium-containing metal nitride include LiₓP_{y}O_{1-z}N_{z}. Examples of the lithium-containing transition metal oxide include lithium titanium oxide.

As the solid electrolyte, only one of these materials may be used or two or more kinds of these materials may be used in combination.

The solid electrolyte layer 300 may include a solid electrolyte having ionic conductivity.

The solid electrolyte layer 300 may include the binder for binding such as polyethylene oxide or polyvinylidene fluoride, in addition to the solid electrolyte described above.

The solid electrolyte layer 300 may have a thickness greater than or equal to 5 μm and less than or equal to 150 μm.

The material of the solid electrolyte may include aggregates of particles. Alternatively, the material of the solid electrolyte may include a sintered structure.

### Second Embodiment

In the following, a description is given of a battery according to a second embodiment. The matters described in the first embodiment may be omitted appropriately.

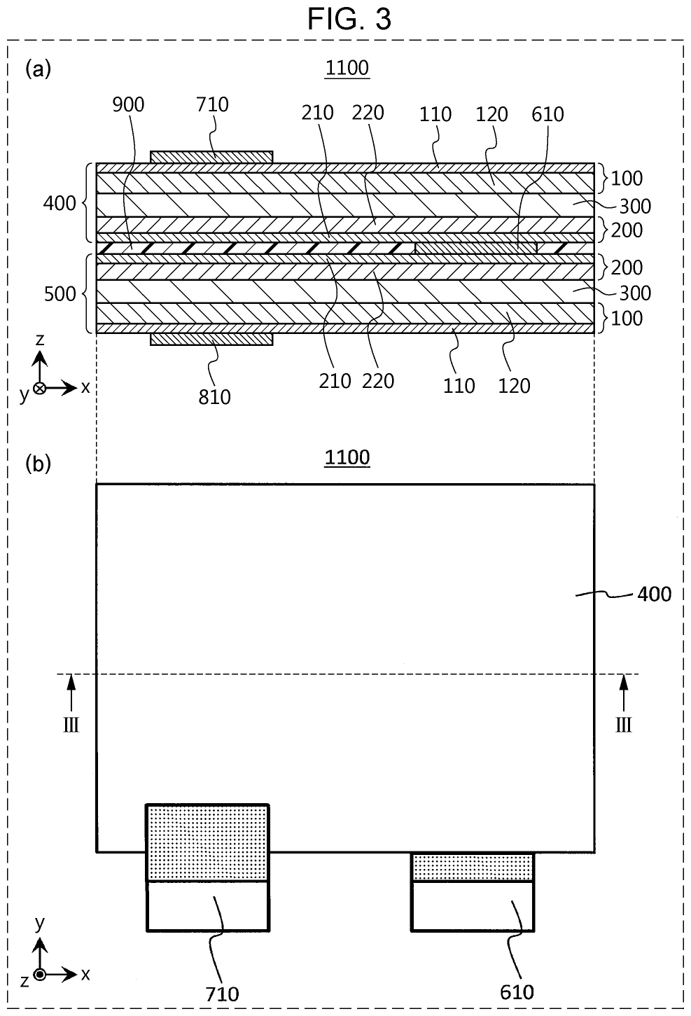

FIG. 3 is a sectional view and a plan view illustrating a schematic configuration of a battery 1100 according to the second embodiment.

FIG. 3(a) is a sectional view of the battery 1100 according to the second embodiment. FIG. 3(b) is a plan view of the battery 1100 according to the second embodiment when viewed from a positive side in a z-axis direction. FIG. 3(a) illustrates a cross section at a position depicted by III-III line of FIG. 2(b).

As illustrated in FIG. 3, unlike the first lead terminal 600 in the battery 1000 according to the first embodiment, in the battery 1100, an embossed shape of the first lead terminal 610 is partially arranged in the non-contact portion. Except for this point, the first lead terminal 610 is the same as the first lead terminal 600 described in the first embodiment. Note that in FIG. 3(b), the embossed shape provided on the first lead terminal 610 is represented by dot pattern applied to the first lead terminal 610.

According to the above configuration, it is possible to reduce the stress on the first lead terminal 610 sandwiched between hard battery elements, the stress being applied due to thermal cycles and restraint pressure. As a result, it is possible to suppress damage to the first lead terminal 610. Furthermore, the embossed shape provided on a drawn portion of the first lead terminal 610 from the side surface of the battery 1100 suppresses damage caused in a region that is easily rubbed due to a contact between the first lead terminal 610 and the side surface of the battery 1100. These can improve mechanical reliability of the first lead terminal 610.

The embossed shape may also be provided on a contact portion in the first lead terminal 610 that is in contact with at least one selected from the group of the first battery element 400 and the second battery element 500. That is, the contact portion of the first lead terminal 610 may have a second embossed shape at least on a part of the surface. A description of a configuration of the second embossed shape provided in the contact portion is the same as the description of the configuration of the first embossed shape described in detail in the first embodiment. Thus, here, a detailed description thereof is omitted.

In the battery 1100 according to the second embodiment, the embossed shape may be arranged in both of the non-contact portion and the contact portion of the first lead terminal 610. The embossed shape of the first lead terminal 610 may be formed continuously in the contact portion and the non-contact portion. Note that in the battery 1100 illustrated in FIG. 3, a part of the surface of the non-contact portion has no embossed shape.

A width of the embossed shape in the non-contact portion of the first lead terminal 610 (that is, a distance from the outer edge of the battery element to the area of the non-contact portion where there is no embossed shape) may be, for example, in a range of not less than a thickness of the first lead terminal 610 and not more than the thickness of the battery element. This can suppress bending of the first lead terminal 610 at hard side corners of the battery 1100. As a result, the first lead terminal 610 is not easily damaged in the vicinity of the drawn portion.

The embossed shaped described above may further be provided on a second lead terminal 710 and a third lead terminal 810. Note that in FIG. 3(b), the embossed shape provided on the second lead terminal 710 is represented by dot pattern applied to the second lead terminal 710.

### Third Embodiment

In the following, a description is given of a battery according to a third embodiment. The matters described in the embodiments described above may be omitted appropriately.

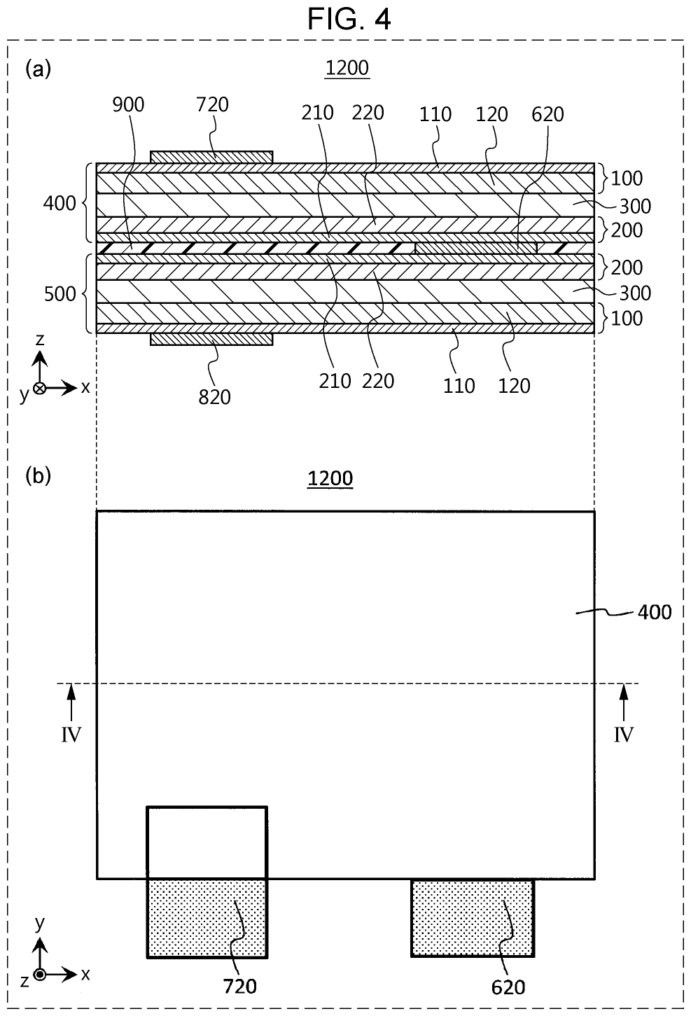

FIG. 4 is a sectional view and a plan view illustrating a schematic configuration of a battery 1200 according to the third embodiment.

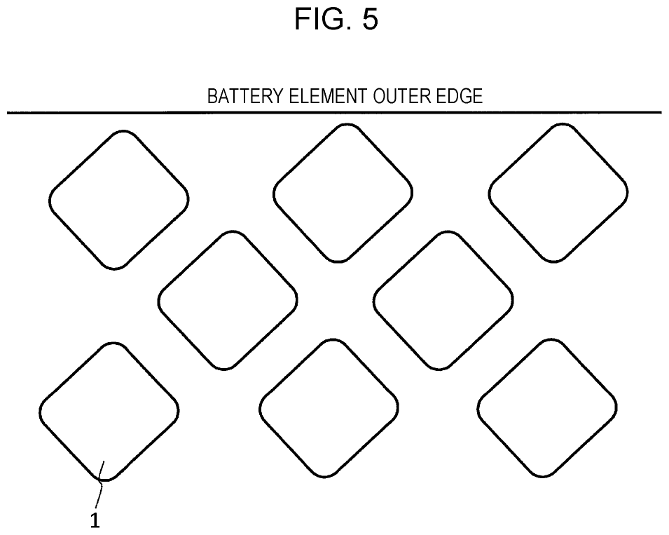

FIG. 4(a) is a sectional view of the battery 1200 according to the third embodiment. FIG. 4(b) is a plan view of the battery 1200 according to the third embodiment when viewed from the positive side in the z-axis direction. FIG. 4(a) illustrates a cross section at a position depicted by Iv-Iv line of FIG. 4(b). FIG. 5 is a plan view illustrating an outer edge and a schematic configuration of the embossed pattern of the battery 1200 according to the third embodiment.

As illustrated in FIGS. 4 and 5, in the battery 1200, an embossed pattern is provided on a non-contact portion of the first lead terminal 620 as the first embossed shape. As illustrated in FIG. 5, in this embossed pattern, an arrangement direction of an embossed unit shape 1 is not parallel to a direction in which the outer edges of the first battery element 400 and the second battery element 500 extend, in plan view. That is, the arrangement direction has an inclination angle with respect to the direction in which the outer edges of the first battery element 400 and the second battery element 500 extend, and may have the inclination angle of approximately 45 degrees, for example. As a result, the pattern is evenly arranged in the left and right with respect to a perpendicular line to the side surface of the battery 1200.

With the above configuration, the first lead terminal 620 is provided, evenly in the left and right (for example, evenly in a direction of ±45 degrees), with a characteristic of being able to expand and shrink due to the embossed shape, that is tensile stress, with respect to the perpendicular line to the side surface of the battery 1200. As a result, the first lead terminal 620 can absorb stress over a wide range to various stress directions, such as the perpendicular direction to the side surface of the battery 1200 and the direction along the outer edge. Therefore, such an embossed pattern also reduces the damage to the first lead terminal 620.

The embossed pattern described above may further be provided on a second lead terminal 720 and a third lead terminal 820.

### Fourth Embodiment

In the following, a description is given of a battery according to a fourth embodiment. The matters described in the embodiments described above may be omitted appropriately.

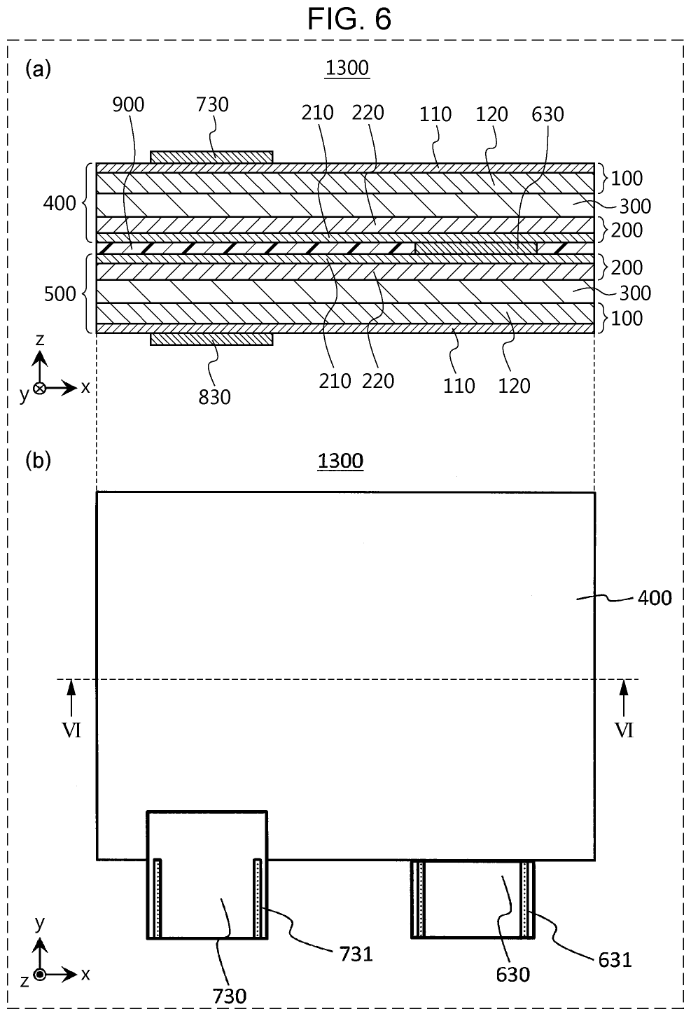

FIG. 6 is a sectional view and a plan view illustrating a schematic configuration of a battery 1300 according to the fourth embodiment.

FIG. 6(a) is a sectional view of the battery 1300 according to the fourth embodiment. FIG. 6(b) is a plan view of the battery 1300 according to the fourth embodiment when viewed from the positive side in the z-axis direction. FIG. 6(a) illustrates a cross section at a position depicted by VI-VI line of FIG. 6(b).

As illustrated in FIG. 6, in the battery 1300, the first embossed shape includes a plurality of linear embossed shapes. The plurality of linear embossed shapes 631 may be arranged in parallel to each other, as illustrated in FIG. 6. In this case, the linear embossed shapes 631 may be arranged in parallel so as to extend with respect to a long side of a first lead terminal 630.

According to the above configuration, it is possible to divide, by the linear embossed shapes, the progress of damage from an outer edge part of the first lead terminal 630, which is easily damaged, and to absorb and control the progress of damage.

It is better to provide the linear embossed shapes 631 in the vicinity of both long sides that are easily damaged, in the first lead terminal 630. For example, if two linear embossed shapes 631 parallel to each other are provided, stress will be dispersed similarly between the two parallel linear embossed shapes.

Although the plurality of linear embossed shapes 631 may be arranged parallel to each other, as illustrated in FIG. 6, they may not be parallel to each other. When the plurality of linear embossed shapes 631 is not parallel to each other, distribution of the stress (reduction of concentration) between the embossments will be advantageous.

With the effect described above, it is possible to suppress the first lead terminal 630 from being broken across the first lead terminal 630. This can reduce the occurrence of circuit disconnection due to the damage of the first lead terminal 630. Therefore, it is possible to realize a highly reliable and large capacity battery.

Note that FIG. 6(b) illustrates an example in which along the both long sides of the first lead terminal 630, the one linear embossed shape 631 each is provided, that is, a total of the two linear embossed shapes 631 are provided. However, the embossed pattern is not limited to this configuration and additional linear embossed shapes or a different embossed pattern may be provided. For example, additional one or two or more linear embossed shapes may be arranged, in the central part of the two parallel linear embossed shapes.

The plurality of linear embossed shapes may have the same shape and size to each other or may be different from each other.

The plurality of linear embossed shapes as those provided in the first lead terminal 630 may be further provided in a second lead terminal 730 and a third lead terminal 830. As illustrated in FIG. 6(b), a linear embossed shape 731 arranged so as to extend parallel to a long side of the second lead terminal 730, for example, may be provided, in the second lead terminal 730.

### Fifth Embodiment

In the following, a description is given of a battery according to a fifth embodiment. The matters described in the embodiments described above may be omitted appropriately.

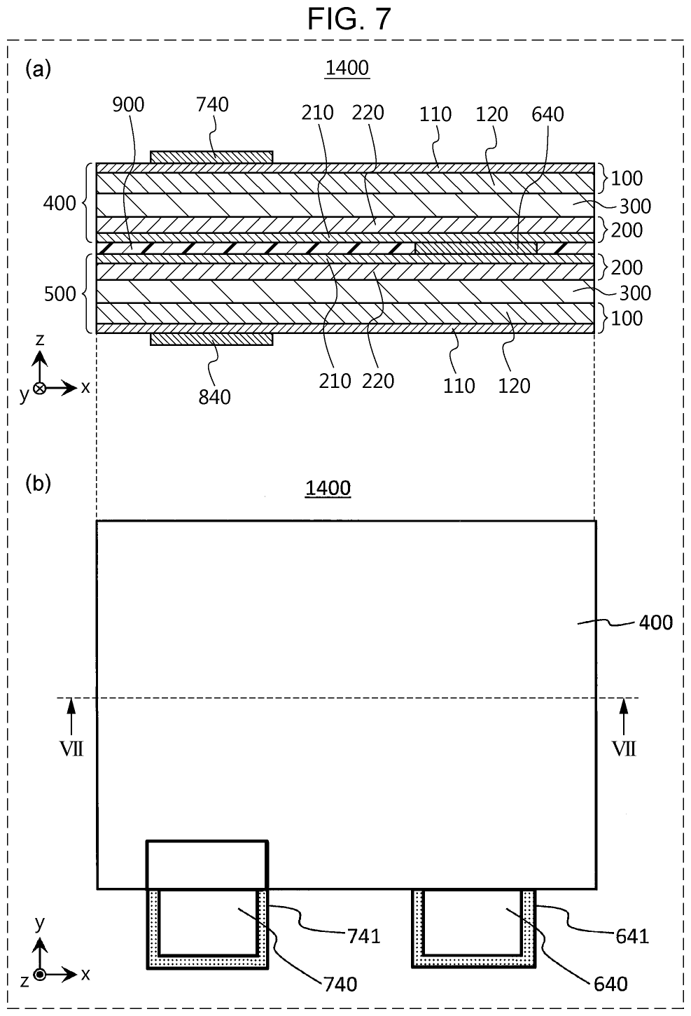

FIG. 7 is a sectional view and a plan view illustrating a schematic configuration of a battery 1400 according to the fifth embodiment.

FIG. 7(a) is a sectional view of the battery 1400 according to the fifth embodiment. FIG. 7(b) is a plan view of the battery 1400 according to the fifth embodiment when viewed from the positive side in the z-axis direction. FIG. 7(a) illustrates a cross section at a position depicted by VII-VII line of FIG. 7(b).

As illustrated in FIG. 7, in the battery 1400, only in an outer edge part of a first lead terminal 640, an embossed shape 641 is provided along the outer edge. That is, no embossed shape is provided in a central part of the first lead terminal 640.

The outer edge part of the lead terminal, which is susceptible to burrs or scratches during processing, easily becomes the starting point of damage. Therefore, provision of the embossed shape 641 along the outer edge of the first lead terminal 640 makes it possible to reduce progress resulting in damage. This can suppress breakage of the first lead terminal 640.

For example, a width of the embossed shape 641 from the outer edge of the first lead terminal 640 may be about a normal amount of burr deformation, that is, half or more of a thickness of the first lead terminal 640, if measures are taken against burrs in, for example, press punching processing. On the other hand, in the case of etching processing, little processing burr occurs, but abrasion and scratches (normally, scratches of a few microns) may occur in a handling step of the manufacturing process. Therefore, provision of the embossed shape 641 will enhance stress resistance of the first lead terminal 640. If measures are taken against defects due to the etching processing, the width of the embossed shape 641 from the outer edge may be smaller than the width of the embossed shape 641 for the measures against the punching processing described above, and may be, for example, less than or equal to half of the thickness of the first lead terminal 640. As such, the width of the embossed shape from the outer edge may be set according to a degree of the burrs and scratches on the outer edge part of the lead terminal. The width of the embossed shape 641 is not specifically limited. In addition, if scratches or burrs occur only at a specific location, the embossed shape may be provided only around the outer edge part of the specific location. Alternatively, the width of the embossed shape may be set larger only around the outer edge part of the specific location.

According to the above configuration, it is possible to suppress the damage of the lead terminal due to defects (scratches or burrs, for example) of the outer edge part of the lead terminal. Therefore, it is possible to realize the battery 1400 that is highly reliable and has high energy density and large capacity.

The embossed shape as provided in the first lead terminal 630 may be further provided in a second lead terminal 740 and a third lead terminal 840. As illustrated in FIG. 7(b), in the second lead terminal 740, an embossed shape 741 may be provided along an outer edge only in the outer edge part of the second lead terminal 740.

### Sixth Embodiment

In the following, a description is given of a battery according to a sixth embodiment. The matters described in the embodiments described above may be omitted appropriately.

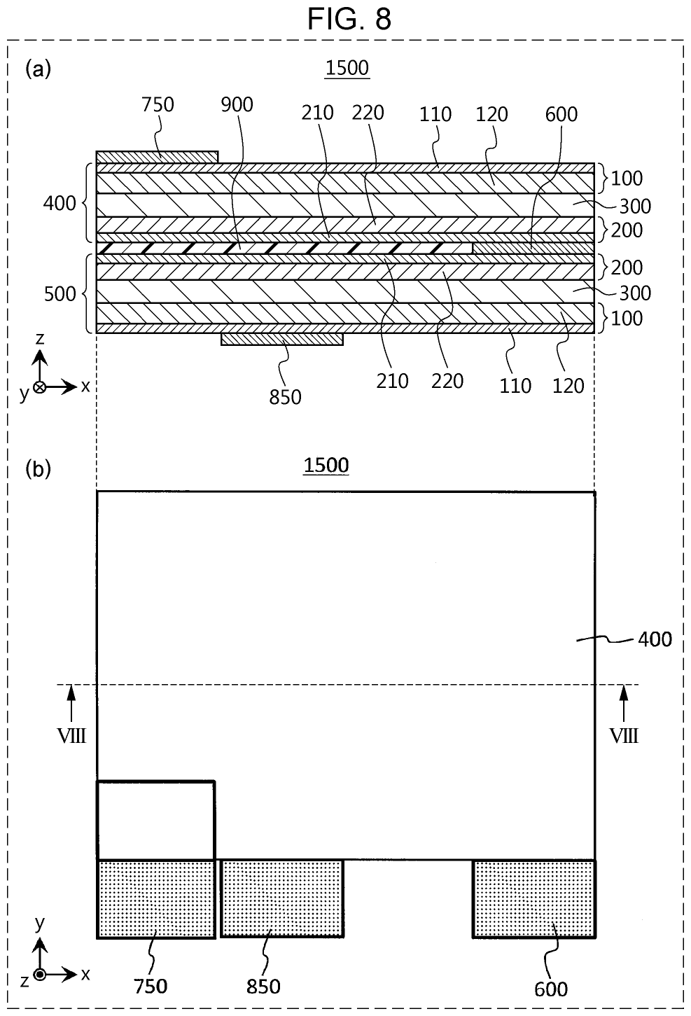

FIG. 8 is a sectional view and a plan view illustrating a schematic configuration of a battery 1500 according to the sixth embodiment.

FIG. 8(a) is a sectional view of the battery 1500 according to the sixth embodiment. FIG. 8(b) is a plan view of the battery 1500 according to the sixth embodiment when viewed from the positive side in the z-axis direction. FIG. 8(a) illustrates a cross section at a position depicted by VIII-VIII line of FIG. 8(b).

As illustrated in FIG. 8(b), in plan view of the battery 1500, a second lead terminal 750 is arranged so as not to overlap a third lead terminal 850. Other configurations of the battery 1500 is the same as those of the battery 1000 according to the first embodiment. Note that in FIG. 8(b), the embossed shape provided in the lead terminal is represented by hatching applied to the lead terminal.

According to the above configuration, the drawn portion of the lead terminal on the surface side of the battery element is dispersed rather than being concentrated in plan view. Therefore, it is possible to disperse the stress due to shock and vibration or the like applied to the battery 1500 over a wide range of the side surface of the battery element. This suppresses cracks caused in the drawn portion of the lead terminal on the battery element surface side. Note that the crack is a crack that occurs when the lead terminal is pulled out, destroying the battery element. Furthermore, this also provides workings and effects of suppressing structural defects such as delamination in the drawn portion of the lead terminal.

In addition, although not illustrated, the second lead terminal 750 may be arranged so as to overlap only a part of the third lead terminal 850 in plan view of the battery 1500.

Also with the configurations described above, the drawn portion of the lead terminal on the side surface of the battery element is not concentrated but dispersed in plan view. Therefore, the stress such as the shock or the like exerted from the lead terminal to the drawn portion of the lead terminal in the battery element is dispersed in a wide range of the side surface of the battery element. As a result, it is possible to suppress occurrence of the damage or delamination in the drawn portion of the lead terminal in the battery element.

As described above, the battery according to the sixth battery can improve reliability even for a thin and large-area laminated battery.

### Method of Manufacturing Battery

In the following, a description is given of a method of manufacturing the battery according to the present disclosure. Here, a method of manufacturing the battery 1000 according to the first embodiment is described, by way of example.

A description is given of a method of manufacturing the first battery element 400 and the second battery element 500.

First, each paste used in print forming of the positive electrode active material layer and the negative electrode active material layer is made. As a solid electrolyte raw material to be used in the mixed agent of each of the positive electrode active material layer and the negative electrode active material layer, are prepared, for example, Li₂S—P₂S₅-based sulfide glass powders which have an average particle size of approximately 10 μm and has triclinic crystals as a main component. The glass powders have the ionic conductivity of, for example, 2×10⁻³ S/cm to 5×10⁻³ S/cm. As the positive electrode active material, are used, for example, powders of Li/Ni/Co/Al composite oxide (LiNi_{0.8}Co_{0.15}Al_{0.05}O₂, for example) having the average particle size of approximately 5 μm and a layered structure. A positive electrode active material layer paste is made by dispersing in an organic solution, or the like, a mixed agent containing the positive electrode active material and the glass powders that are described above. As a negative electrode active material, natural graphite powders having the average particle size of approximately 10 μm are used. A negative electrode active material layer paste is made by dispersing in an organic solution, or the like, a mixed agent containing the negative electrode active material and the glass powders that are described above.

Then, Cu foils having a thickness of, for example, approximately 15 lam are prepared as the positive electrode current collector and the negative electrode current collector. By screen printing method, the positive electrode active material layer paste and the negative electrode active material layer paste are respectively printed on one surface of each Cu foil in a predetermined shape and in a thickness of approximately 50 μm to approximately 100 μm. The positive electrode active material layer paste and the negative electrode active material layer paste are dried in a range from 80° C. to 130° C. In this manner, the positive electrode active material layer is formed on the positive electrode current collector, and the negative electrode active material layer is formed on the negative electrode current collector. As a result, a positive electrode layer and a negative electrode layer are obtained. The positive electrode layer and the negative electrode layer have a thickness greater than or equal to 30 μm and less than or equal to 60 μm.

Then, a solid electrolyte layer paste is prepared by dispersing the above glass powders in an organic solvent or the like. On the positive electrode layer and the negative electrode layer, the solid electrolyte layer paste described above is printed with a thickness of, for example, approximately 100 μm using a metal mask. Thereafter, the positive electrode and the negative electrode on which the solid electrolyte layer paste is printed are dried in a range from 80° C. to 130° C.

Then, the solid electrolyte printed on the positive electrode active material layer and the solid electrolyte printed on the negative electrode active material layer are laminated so that they are in contact with and face each other.

Then, an elastic sheet having an elastic modulus of approximately 5×10⁶ Pa is inserted between pressure mold plates, specifically, between a laminated body and the pressure mold plate, that is, on the upper surface of the current collector of the laminated body. The elastic sheet has a thickness of, for example, 70 μm. Subsequently, pressure is applied to the laminated body for 90 seconds while heating the pressure mold plates to 50° C. at a pressure of 300 MPa, for example.

Through the above steps, the first battery element 400 and the second battery element 500 are manufactured.

Then, when the first battery element 400 and the second battery element 500 are laminated, a thermosetting conductive paste containing silver particles is screen printed in a thickness of approximately 20 to 30 lam onto the surface of the current collector to which the first battery element 400 is bonded. Then, the second battery element 500 is arranged at a predetermined position and crimped so that a conductive foil (for example, Cu foil) with lead terminals is sandwiched therebetween. The conductive foil is made of Cu, for example, and has a thickness of approximately 12 μm. In the battery 1000 according to the first embodiment, the first battery element 400 and the second battery element 500 are electrically coupled in parallel. Therefore, in this case, the same polarities are bonded together. In addition, by being pressurized in advance with a die, the lead terminals are embossed at least on a part of the surface that is the non-contact portion not in contact with any of the first battery element 400 and the second battery element 500. A multi-layered battery can be produced by repeating this process. Thereafter, they are left to stand while being subjected to a pressure of, for example, approximately 1 kg/cm², heat-cured at a temperature of approximately 100 to 300° C. for 60 minutes, and then gradually cooled down to room temperature. As a result, a battery in which the first battery element 400 and the second battery element 500 are coupled in parallel, that is, the battery 1000 can be manufactured.

It should be noted that the method and order of forming a battery is not limited to the example described above.

For example, an insulating resin material may be applied to the side surface of the battery element by screen printing.

In the manufacturing method described above, an example in which the positive electrode active material layer paste, the negative electrode active material layer paste, the solid electrolyte layer paste, and the conductor paste are applied by printing is illustrated, but the present disclosure is not limited to this. As a printing method, for example, a doctor blade method, a calendar method, a spin coating method, a dip coating method, an inkjet method, an offset method, a die coating method, a spray method, or the like may also be used.

In the manufacturing method described above, although a thermosetting conductor paste containing silver metal particles is used as an example of the conductor paste, the present disclosure is not limited to this. Also, the resin used for the thermosetting conductive paste may be any resin as far as it functions as a binder for binding. A suitable resin is selected depending on the manufacturing process to be adopted, such as printability and coatability. Resins used in thermosetting conductor pastes include, for example, thermosetting resins. Examples of the thermosetting resins include (i) amino resins such as urea resins, melamine resins, and guanamine resins; (ii) epoxy resins such as bisphenol A type, bisphenol F type, phenol novolac type, and alicyclic; (iii) oxetane resins, (iv) phenolic resins such as resole type and novolac type, and (v) silicone-modified organic resins such as silicone epoxy and silicone polyester. Only one of these materials may be used for the resin, or two or more of these materials may be used in combination.

Although the battery and the manufacturing method thereof according to the present disclosure have been described above based on the embodiments, the present disclosure is not limited to these embodiments. As far as they do not depart from the spirit of the present disclosure, embodiments to which various modifications that those skilled in the art can conceive are applied and another form constructed by combining some components in different embodiments are also included in the scope of the present disclosure.

The battery according to the present disclosure may be used, for example, as a secondary battery such as an all-solid-state battery used in various electronic devices or automobiles.

What is claimed is:

1. A battery comprising:
a first battery element;
a second battery element laminated on the first battery element and electrically coupled with the first battery element in parallel; and
a first lead terminal electrically coupled with the first battery element and the second battery element, wherein
the first lead terminal has a non-contact portion that is not in contact with any of the first battery element and the second battery element, and
the non-contact portion has a first embossed shape at least on a part of a surface.

2. The battery according to claim 1, wherein
The first embossed shape has a periodic structure in which embossed unit shapes are repeatedly arranged at predetermined intervals.

3. The battery according to claim 2, wherein
the predetermined intervals are greater than or equal to a thickness of the first lead terminal.

4. The battery according to claim 1, wherein
the first embossed shape includes a plurality of linear embossed shapes.

5. The battery according to claim 4, wherein
a direction in which the linear embossed shapes extend intersects a direction in which outer edges of the first battery element and the second battery element extend in plan view.

6. The battery according to claim 1, wherein
the first lead terminal has a contact portion, the contact portion of the first lead terminal has a second embossed shape at least on a part of a surface.

7. The battery according to claim 1, wherein
the first embossed shape is arranged in an outer edge part of the first lead terminal.

8. The battery according to claim 1 further comprising:
a second lead terminal electrically coupled with the first battery element; and
a third lead terminal electrically coupled with the second battery element, wherein
the second lead terminal, the first battery element, the first lead terminal, the second battery element, and the third lead terminal are arranged in this order in a laminating direction of the first battery element and the second battery element.

9. The battery according to claim 8, wherein
the second lead terminal only partially overlaps the third lead terminal in plan view.

10. The battery according to claim 8, wherein
the second lead terminal does not overlap the third lead terminal in plan view.

11. The battery according to claim 8, wherein
the second lead terminal has a same shape as the third lead terminal in plan view.

12. The battery according to claim 1, wherein
the first battery element and the second battery element are solid-state batteries.

13. The battery according to claim 1, wherein
the first embossed shape has maximum height roughness Rz greater than or equal to 10 μm.

14. The battery according to claim 1, wherein
the first embossed shape has the maximum height roughness Rz less than or equal to 15 μm.

15. The battery according to claim 1, wherein
the first lead terminal is arranged between the first battery element and the second battery element.

16. The battery according to claim 1, wherein
the first lead terminal has a contact portion that is in contact with at least one battery element selected from the group consisting of the first battery element and the second battery element.
